(19) United States
(12) Patent Application Publication
(10) Pub. No.: US 2014/0352996 A1
(43) Pub. Date: Dec. 4, 2014

(54) APPARATUS AND METHOD FOR TRANSFERRING ELECTRICAL POWER TO A ROTATING SHAFT

(71) Applicant: National Oilwell Varco Norway AS, Kristiansand S (NO)

(72) Inventor: Arne Austefjord, Sandnes (NO)

(21) Appl. No.: 14/362,681

(22) PCT Filed: Dec. 6, 2012
(86) PCT No.: PCT/NO2012/050243

§ 371 Date: Jun. 4, 2014

Related U.S. Application Data
(60) Provisional application No. 61/567,848, filed on Dec. 7, 2011.

(51) Int. Cl. B23B 49/00; H02J 5/00; H01F 38/18

(52) U.S. Cl. CPC B23B 49/00; H01F 38/18; H02J 5/005; B23B 2260/062
USPC 173/217; 307/104

(57) ABSTRACT

Apparatus and method for transferring electrical power to a rotating shaft. An apparatus for transferring electrical power to a rotating shaft, the apparatus includes a first winding in a stationary part of the apparatus around the shaft, a second winding on the shaft adjacent to the first winding, a sensing device adapted to sense the rotational frequency of the shaft, and a variable frequency drive. The variable frequency drive is adapted to adjust an input current frequency to the first winding as a function of the rotational frequency of the shaft, whereby a desired output voltage and frequency in the second winding on the shaft is obtained.

### CROSS-REFERENCE TO RELATED APPLICATIONS

The present application is a 35 U.S.C. §371 national stage application of PCT/NO2012/050243 filed Dec. 6, 2012, which claims the benefit of U.S. Provisional Application No. 61/567,848 filed Dec. 7, 2011, both of which are incorporated herein by reference in their entirety for all purposes.

### BACKGROUND

1. Technical Field

The invention relates to an apparatus for transferring electrical power to a rotating shaft. More specifically the invention relates to an apparatus for transferring electrical power to a rotating shaft of variable rotational frequency, where the apparatus comprises a first winding in a stationary part of the apparatus around the shaft and a second winding on the shaft adjacent to the first winding. The invention also relates to a method for transferring electrical power to a rotating shaft.

2. Background of the Technology

During a drilling operation it can be desirable to monitor the operation through various sensing devices, such as strain gauges and temperature sensors, on the shaft. Powering of such sensing devices should be done either by transferring electrical power contactlessly to the shaft or by a power source on the shaft.

It is known to power such sensing devices by batteries provided on the shaft. This could however be disadvantageous due to the need for frequent replacement of the batteries, and also due to safety issues on shutdown of the rotating shaft which then does not automatically shut down the power source on the shaft.

It is also known to power such sensing devices by tapping power of the motor rotating the shaft, which for instance could be an induction motor. However this will reduce the motor power, which could be highly undesirable. Further, if the motor operates at variable speed, this will imply a varying power supply to the sensing devices, which usually are designed to operate at fixed voltages or within fixed voltage intervals.

### SUMMARY

In the drawings and description that follow, like parts are typically marked throughout the specification and drawings with the same reference numerals. The present disclosure is susceptible to embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings and components of the embodiments discussed below may be employed separately or in any suitable combination to produce desired results.

The object of the invention is to remedy or to reduce at least one of the disadvantages of the prior art, or at least to provide a useful alternative to the prior art. The object is achieved by virtue of features disclosed in the following description and in the subsequent claims.

A variable frequency drive, hereinafter name a VFD, is a type of adjustable-speed drive used in electro-mechanical drive systems to control alternating current motor speed and torque by varying motor input and frequency. VFDs are for instance known to be used to control the speed and torque of top drives used in drilling operations.

In a first aspect the invention relates to an apparatus for transferring electrical power to a rotating shaft, the apparatus comprising:
a first winding in a stationary part of the apparatus around the shaft; and
a second winding on the shaft adjacent to the first winding,
a sensing device adapted to sense the rotational frequency of the shaft; and
a variable frequency drive adapted to adjust an input current frequency to the first winding as a function of the rotational frequency of the shaft, whereby a desired output voltage and frequency in the second winding on the shaft can be obtained.

In order to induce current in the windings on the shaft, the input frequency of the current in the first, stationary winding can be higher than the rotational frequency of the shaft. A person skilled in the art will know that in an induction motor it is required that the input frequency to the stator winding is higher than the actual rotational frequency of the rotor in order to induce currents in the windings of the stator.

In one embodiment the apparatus may further comprise a control unit connected to the VFD. The control unit may be a Programmable Logic Controller (PLC) or a micro controller or the like. The control unit may be used to communicate with the VFD to set the desired input frequency. Further, the control unit may communicate with the sensing device adapted to sense the rotational frequency of the shaft. The control unit will thus be able to calculate the input frequency from the VFD to the first winding required to obtain the desired output voltage, and thus to automate the VFD. The calculation of the input frequency from the VFD to the first winding can require input of the specifics of the apparatus, for example the number of input phases, the resistance in the windings, and the transmission of the motor driving the shaft. These specifics will be known to a person skilled in the art. The control unit may further be used to control a second VFD driving the motor running the shaft, and the control unit may be connected to one or more other control units on a local network. A person skilled in the art will also know that the apparatus may comprise a rectifier for rectifying the induced current in the second winding on the stator.

The apparatus may further comprise one or more sensing devices connected to the second winding on the shaft. The sensing devices may be, but are not limited to, one or more of the following devices:
a strain sensing device;
a torsion sensing device;
a vibration sensing device;
a temperature sensing device; and
a pressure sensing device.

The sensing devices are powered from the induced currents in the second winding on the shaft. Since the shaft is already rotated by an external motor, the induced current in the second winding on the shaft can be used to power the sensing devices, and, if needed, various other electronic devices. Thus, only a negligible torque is produced by the apparatus. The required input voltage to the different sensing devices may be used to set the desired input frequency and voltage from the VFD to the first, stationary winding.

The sensing devices may further be connected to a wireless communication unit. The wireless communication unit, which may be of a type known per se, may be used to communicate sensed parameters from the sensing devices to a control unit, which may be the above mentioned control unit or another control unit.

The sensing device for sensing the rotational speed of the rotating shaft may be an encoder connected to a motor driving the rotating shaft. As the transmission from the motor to the rotating shaft is usually known, the obtained value from the encoder can be recalculated into the actual rotational frequency of the shaft. The rotational frequency of the shaft may be calculated in the above mentioned control unit, or it may be calculated elsewhere and transmitted to the control unit via a local network.

In a second aspect the invention relates to a top drive comprising an apparatus for transferring electrical power to a rotating shaft of the top drive. The top drive may be electrically or hydraulically driven.

In a third aspect the invention relates to a method for transferring electrical power to a rotating shaft, the method comprising the steps of:
providing a stationary part around the shaft with a first winding; and
providing a second winding on the shaft adjacent to the first winding,
sensing the rotational frequency of the shaft by means of sensing device; and
based on the rotational frequency of the shaft adjusting an input current frequency to the first winding by means of a variable frequency drive to obtain a desired output voltage and frequency in the second winding on the shaft.

In one embodiment the method may also comprise the step of connecting the variable frequency drive to a control unit. The connection may be done by a cable or wirelessly.

The method may further comprise the step of connecting the second winding to one or more of, but not limited to, the following devices:
a strain sensing device;
a torsion sensing device;
a vibration sensing device;
a temperature sensing device; and
a pressure sensing device.
   If needed the second winding may further be connected to other electronic devices on or near the shaft.

The method may further comprise the step of drilling a hole in the shaft. Cables may be placed in the drilled hole for connecting one or more of the sensing devices to the second winding of the apparatus. This may be advantageous for avoiding cables on the outside of the shaft. When the interior of the shaft is used to carry fluids, for example mud as used in drilling operations, the hole can be drilled in the shaft between the liquid-carrying conduit and the outer surface of the shaft.

The method may further comprise the step of connecting one or more of the sensing devices to a wireless communication unit. The wireless communication unit may communicate parameters sensed by the sensing devices to a control unit.

### BRIEF DESCRIPTION OF THE DRAWINGS

Hereinafter, examples of non-limiting, preferred embodiments are described and depicted on the accompanying drawings. The figures are not necessarily to scale, and certain features and certain views of the figures may be shown exaggerated in scale or in schematic form, and some details of conventional elements may not be shown in the interest of clarity and conciseness.

FIG. 1 shows in a front view a top drive for rotating a drill string;

FIG. 2 shows in a side view the top drive from FIG. 1;

FIG. 3 shows in larger scale a cross section seen through the line A-A from FIG. 1; and

FIG. 4 shows in smaller scale a schematic drawing of an embodiment of the invention.

### NOTATION AND NOMENCLATURE

Certain terms are used throughout the following description and claims to refer to particular system components. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through direct engagement of the devices or through an indirect connection via other devices and connections. The recitation “based on” is intended to mean “based at least in part on.” Therefore, if X is based on Y, X may be based on Y and any number of other factors.

### DETAILED DESCRIPTION

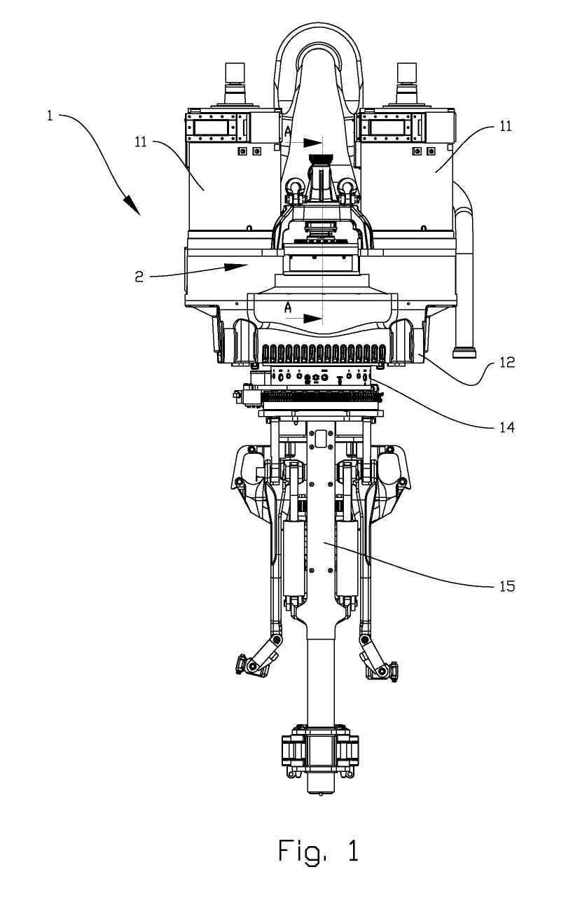

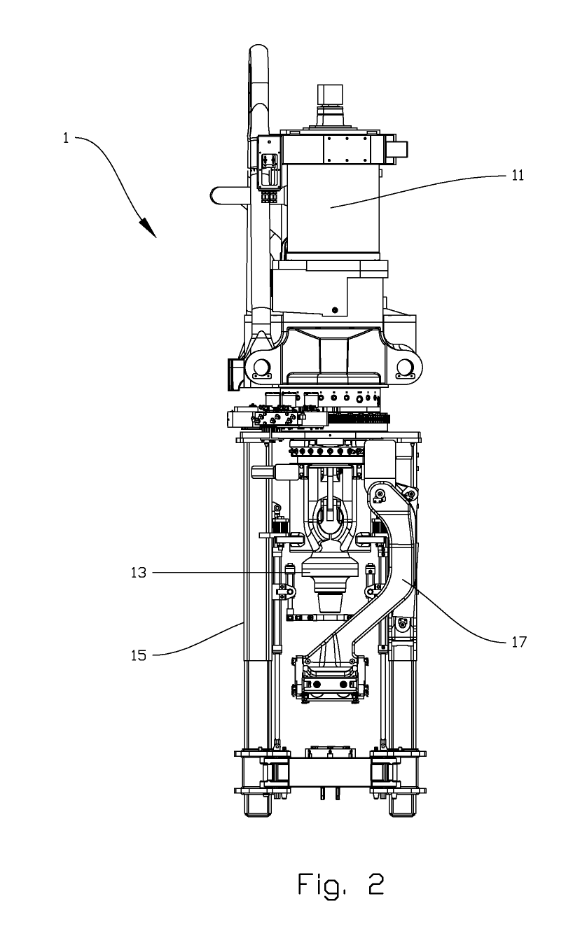

In the following the reference numeral 2 will be used to indicate an apparatus according to the present invention. FIGS. 1 and 2 show a top drive 1 for use in drilling operations on an oil rig. The top drive 1 as shown in the two figures will be known to a person skilled in the art, and it will therefore only be briefly explained with reference to the figures. Electric motors 11 are used to power the top drive 1, and to rotate a main shaft 13. The power is transmitted from the motors 11 to the main shaft 13 via a gearbox 12. The top drive 1 also comprises a hydraulic swivel 14 for connecting a mud hose to a not shown drill string via the shaft 13. The top drive 1 is also shown comprising a pipe handler 15 and a link tilt 17 for collecting and handling not shown pipes.

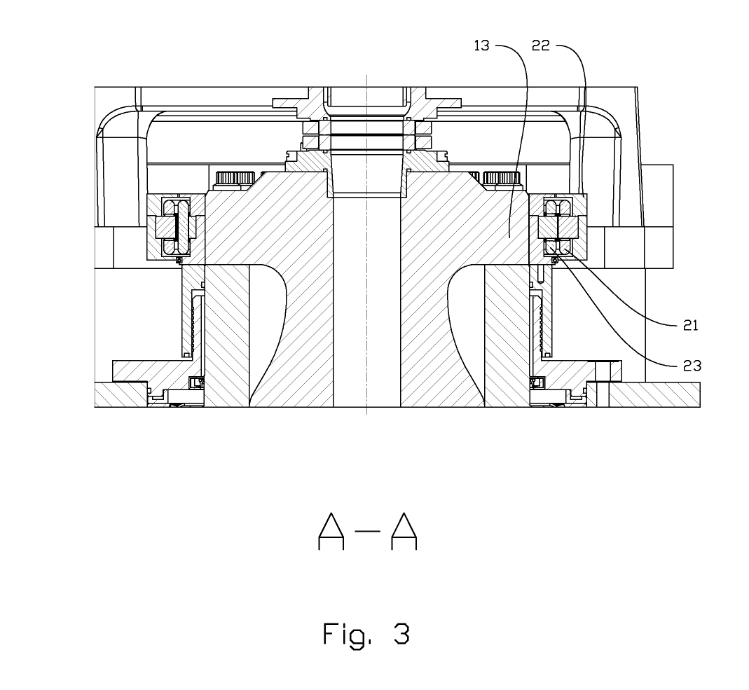

FIG. 3 shows a cross section of the top drive 1 seen through the cut A-A as indicated in FIG. 1. A stationary part 22 of the top drive 1 is provided with a first winding 21. The first winding 21 is connected to a not shown VFD from which the first winding 21 is supplied with current of varying frequency and voltage. The main shaft 13 is provided with a second winding 23 adjacent to the first winding 21 of the stationary part 22. The VFD together with the first and second windings 21, 23 are thus adapted to function as an induction motor where current is induced in the second winding 23 as a result of a varying magnetic field from the currents in the first winding 21. However, since the shaft 13 is already powered from the motors 11, there is no need to create an additional torque.

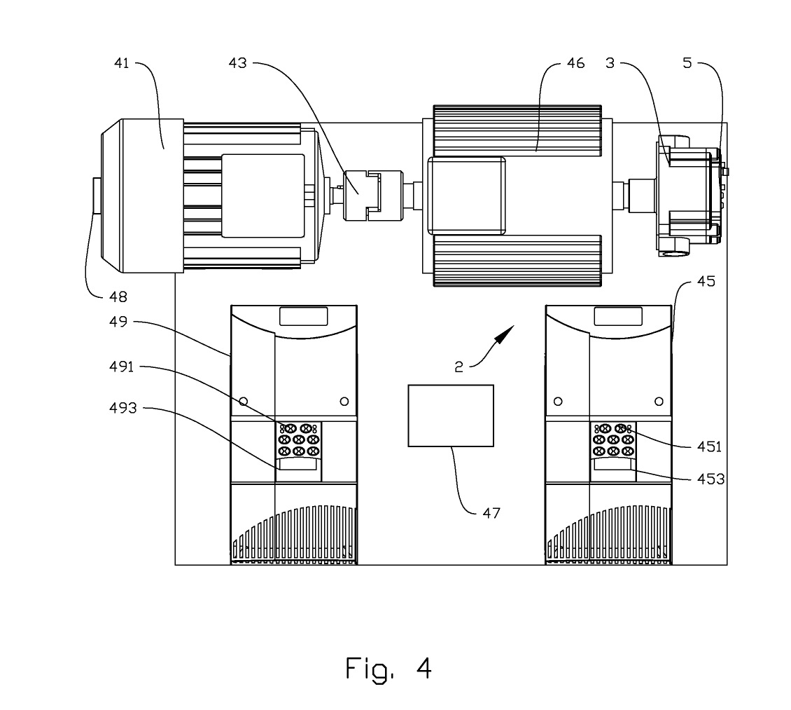

FIG. 4 shows a schematic test setup for an apparatus 2 according to the invention. A VFD 49 is connected to a squirrel cage induction motor 41. A shaft 43 is rotated by the induction motor 41 and extends through a second induction motor 46. The second induction motor 46 is provided with first and second not shown windings corresponding to the first and second windings 21, 23 shown on FIG. 3. Instead of letting the second induction motor 46 create a torque and rotate the shaft 43, the current generated in the second, not shown winding on the shaft 43 is used to power an electrical instrument 3 rotating with the shaft 43. In general, the resistance in the second not shown winding on the shaft 43 is quite low, and the voltage drop therefore mainly occurs in an external circuit, for example in the electrical instrument 3 and its connection to the second, not shown winding. The current in the second winding is therefore significantly reduced, and the second induction motor 46 only produces a negligible torque. A VFD 45 is driving the second induction motor 46. The VFD 45 may be operated manually as it is equipped with control buttons 451 and an alphanumeric display 453, or the VFD 45 can be switched to an automatic mode where it is controlled by a control unit 47. The control unit 47 is further connected to a rotary incremental encoder 48 on the induction motor 41, either directly or via a local network, whereby the control unit 47, by knowing the transmission of the induction motor 41, can calculate the rotational frequency of the shaft 43 by the information received from the encoder 48, and thus set the required input frequency and voltage to the induction motor 46. The control unit 47 is further connected to the VFD 49 driving the first induction motor 41. The VFD 49 driving the first induction motor 41 may also be switched to a manual mode where it can be operated by control buttons 491 and an alphanumeric display 493.

The electrical instrument 3 is connected to a wireless communication unit 5, which is communicating with the control unit 47 or with other not shown control units. The electrical instrument 3 may be one or more of the sensing devices listed above, which are devices adapted for sensing strain, torsion, vibrations and temperature in or near the shaft 43, and further for sensing pressure in the shaft 43. The latter may be especially useful when the shaft 43 is connected to a drill string through which mud flow during drilling operations. The latter may significantly improve the accuracy of mud pulse telemetry, where the mud pressure according to prior art is measured externally from the drill string.

The above discussion is meant to be illustrative of various embodiments of the present invention. Numerous variations and modifications will become apparent to those skilled in the art once the above disclosure is fully appreciated. It is intended that the following claims be interpreted to embrace all such variations and modifications.

1. An apparatus for transferring electrical power to a rotating shaft, the apparatus comprising:
a first winding in a stationary part of the apparatus around the shaft;
a second winding on the shaft adjacent to the first winding,
a sensing device adapted to sense the rotational frequency of the shaft and
a variable frequency drive adapted to adjust an input current frequency to the first winding as a function of the rotational frequency of the shaft, whereby a desired output voltage and frequency in the second winding on the shaft can be obtained.

2. The apparatus of claim 1, wherein the apparatus further comprises a control unit connected to the variable frequency drive.

3. The apparatus of claim 1, wherein the second winding on the shaft is connected to one or more of following sensing devices:
a strain sensing device;
a torsion sensing device;
a vibration sensing device;
a temperature sensing device; and
a pressure sensing device.

4. The apparatus of claim 3, wherein one or more of the sensing devices are connected to a wireless communication unit.

5. The apparatus of claim 1, wherein the sensing device for sensing the rotational speed of the shaft is an encoder connected to a motor driving the rotating shaft.

6. (canceled)

7. A method for transferring electrical power to a rotating shaft, the method comprising:
providing a stationary part around the shaft with a first winding; and
providing a second winding on the shaft;
sensing the rotational frequency of the shaft by means of a sensing device; and
based on the rotational frequency of the shaft adjusting an input current frequency to the first winding means of a variable frequency drive to obtain a desired output voltage and frequency in the second winding on the shaft.

8. The method of claim 7, further comprising connecting the variable frequency drive to a control unit.

9. The method of claim 7, further comprising connecting the second winding to one or more of the following sensing devices:
a strain sensing device;
a torsion sensing device;
a vibration sensing device;
a temperature sensing device; and
a pressure sensing device.

10. The method of claim 9, further comprising drilling a hole in the shaft through which the second winding is connected to one or more of the sensing devices.

11. The method of claim 9, further comprising connecting one or more of the sensing devices to a wireless communication unit.

12. The apparatus of claim 2, wherein the control unit is configured to determine the input current frequency based on an output of the sensing device and to cause the variable frequency drive to generate the input current frequency.

13. The apparatus of claim 12, wherein the input current frequency is higher than the rotational frequency of the shaft.

14. The method of claim 7, further comprising determining the input current frequency based on the rotational frequency of the shaft and resistance of the first and second windings.

15. The method of claim 7, wherein the input current frequency is higher than the rotational frequency of the shaft.

16. A drilling system, comprising:
a top drive for rotating a drill string, the top drive comprising:
a shaft;
a first motor configured to rotate the shaft;
a sensing device configured to sense rotational frequency of the shaft;
a second motor, comprising:
a stationary winding disposed around the shaft;
a rotating winding on the shaft adjacent to the stationary winding; and
a variable frequency drive configured generate a predetermined output voltage and frequency in the rotating winding by adjusting an input current frequency to the stationary winding as a function of the rotational frequency of the shaft.

17. The drilling system of claim 16, further comprising a control unit coupled to the variable frequency drive, the control unit configured to determine the input control frequency based on the rotational frequency of the shaft and parameters of the second motor.

18. The drilling system of claim 16, where the input current frequency is higher than the rotational frequency of the shaft.

19. The drilling system of claim 16, wherein the sensing device comprises an encoder coupled to the first motor.

20. The drilling system of claim 16, further comprising a sensor disposed in the drill string, the sensor coupled to the rotating winding and powered by the output voltage generated in the rotating winding.

21. The drilling system of claim 20, wherein the sensor comprises at least one of:
a strain sensor;
a torsion sensor;
a vibration sensor;
a temperature sensor; and
a pressure sensor.
